(19) United States
(12) Patent Application Publication
(10) Pub. No.: US 2012/0178007 A1
(43) Pub. Date: Jul. 12, 2012

(54) FUEL CELL CONTROL METHOD AND FUEL CELL CONTROLLER

(75) Inventors: Tengyu CAI, Shenzhen (CN); Junjie ZHANG, Shenzhen (CN); Nanhai LI, Kista (SE); Haijun WU, Shenzhen (CN); Ya HE, Shenzhen (CN); Bin LE, Shenzhen (CN)

(73) Assignee: HUAWEI TECHNOLOGIES CO., LTD., Shenzhen (CN)

(21) Appl. No.: 13/419,704

(22) Filed: Mar. 14, 2012

Related U.S. Application Data
(63) Continuation of application No. PCT/CN2010/076834, filed on Sep. 13, 2010.

(30) Foreign Application Priority Data
Sep. 14, 2009 (CN) 200910176417.2

(51) Int. Cl. H01M 8/04

(52) U.S. Cl. 429/431

(57) ABSTRACT

Embodiments of the present invention disclose a fuel cell control method. The method includes: obtaining a current output power of a fuel cell; obtaining a current inlet-outlet temperature difference of a fuel cell stack, where the current inlet-outlet temperature difference of the stack is a difference between a stack temperature and an ambient temperature; controlling a hydrogen exhaust solenoid valve according to the output power and working parameters of the hydrogen exhaust solenoid valve corresponding to the output power; and controlling the stack temperature according to the output power and the current inlet-outlet temperature difference of the stack, so that the amount of water generated in the fuel cell is equal to the amount of water discharged. In the embodiments, the fuel cell can work in a preferred state, steady output of the cell is ensured, and the service life is improved.

### CROSS-REFERENCE TO RELATED APPLICATIONS

This application is a continuation of International Application No. PCT/CN2010/076834, filed on Sep. 13, 2010, which claims priority to Chinese Patent Application No. 200910176417.2, filed on Sep. 14, 2009, both of which are hereby incorporated by reference in their entireties.

### FIELD OF THE INVENTION

The present invention relates to the field of automatic control, and in particular, to a fuel cell control method and controller.

### BACKGROUND OF THE INVENTION

A fuel cell is a power generation device for converting chemical energy of fuel into direct current electric energy directly by means of an electrochemical reaction without burning. The working principle is to convert chemical energy of a substance into electric energy through an electrochemical reaction, where the substance required for the fuel cell to perform the chemical reaction is constantly supplied externally. Provided that the fuel is supplied, electric energy and heat can be continuously output. In brief, the fuel cell is an energy conversion device.

Among numerous fuel cells, due to the advantages of high energy conversion efficiency because no hydrogen-oxygen combustion is involved in the power generation process and the conversion is not limited by the Carnot cycle, and no pollution generated in power generation, proton exchange membrane fuel cells, as a new generation of power generation technology, have wide application prospects.

However, as for conventional water-cooling humidified fuel cells, during reaction, the proton exchange membrane is required to contain sufficient liquid water, if the amount of water generated cannot meet the requirement for the water content in the proton exchange membrane, external humidification is required to be performed, but it is proved that the implementation cannot be performed properly from principle. Therefore, in order to ensure the proton exchange membrane is in a good working state, a series of external assurance measures need to be developed based on the design. As a result, the conventional water-cooling humidified fuel cell has a large and complex auxiliary system and a large monitoring system, and moreover, parameters of the multiple auxiliary systems are coupled to each other and have influence on each other, resulting in many difficulties in system control. Additionally, as for different control objects and control parameters, different control algorithms and circuits need to be adopted, so as to optimize the control speed and the control accuracy of the systems, and minimize the cost of the control system. However, in the current circumstances, the requirements cannot be met simultaneously.

Accordingly, air-cooling self-humidified fuel cells with a simple system structure are developed, and because this type fuel cell system has the self-humidifying capability and adopts the air cooling, the auxiliary system is greatly simplified theoretically. However, currently, due to lack of sufficient knowledge of operation of air-cooling fuel cells, in the control process of the fuel cell, it is difficult to grasp the key factor in the reaction of the fuel cell, so the fuel cell cannot work in a preferred state, resulting in unsteady output and a short service life.

### SUMMARY OF THE INVENTION

Accordingly, embodiments of the present invention provide a fuel cell control method and a fuel cell controller, so that a fuel cell can work in a preferred state.

The embodiments of the present invention are implemented as follows:

An embodiment of the present invention provides a fuel cell control method, where the method includes:

obtaining a current output power of a fuel cell;

obtaining a current inlet-outlet temperature difference of a fuel cell stack, where the current inlet-outlet temperature difference of the stack is a difference between a stack temperature and an ambient temperature;

controlling a hydrogen exhaust solenoid valve according to the output power and working parameters of the hydrogen exhaust solenoid valve corresponding to the output power; and

controlling the stack temperature according to the output power and the current inlet-outlet temperature difference of the stack, so that the amount of water generated in the fuel cell is equal to the amount of water discharged.

An embodiment of the present invention provides a fuel cell controller, where the controller includes:

an output power obtaining unit, configured to obtain a current output power of a fuel cell;

a temperature difference obtaining unit, configured to obtain a current inlet-outlet temperature difference of a fuel cell stack, where the current inlet-outlet temperature difference of the stack is a difference between a stack temperature and an ambient temperature;

a hydrogen exhaust solenoid valve control unit, configured to control a hydrogen exhaust solenoid valve according to the output power of the fuel cell obtained by the output power obtaining unit and working parameters of the hydrogen exhaust solenoid valve corresponding to the output power; and

a stack temperature control unit, configured to control the stack temperature according to the output power of the fuel cell obtained by the output power obtaining unit and the fuel cell stack inlet-outlet temperature difference obtained by the temperature difference obtaining unit, so that the amount of water generated in the fuel cell is equal to the amount of water discharged.

As compared with the prior art, the technical solutions provided by the embodiments of the present invention have the following advantages and characteristics: in the embodiments of the present invention, a current output power of a fuel cell and a current inlet-outlet temperature difference of a stack are obtained, and relevant parameters are regulated and controlled according to the obtained values during a fuel cell reaction to achieve water balance in the fuel cell, so that the fuel cell can work in a preferred state, steady output of the cell is ensured, and the service life is improved.

### BRIEF DESCRIPTION OF THE DRAWINGS

To illustrate the technical solutions according to the embodiments of the present invention or in the prior art more clearly, the accompanying drawings required for describing the embodiments or the prior art are introduced below briefly. Apparently, the accompanying drawings in the following descriptions merely show some of the embodiments of the present invention, and persons skilled in the art can obtain other drawings according to the accompanying drawings without creative efforts.

FIG. 1 is a flowchart of a fuel cell control method according to an embodiment of the present invention;

FIG. 2 is a schematic structural diagram of a fuel cell controller according to an embodiment of the present invention;

FIG. 3 is a schematic structural diagram of a unit in a fuel cell controller according to an embodiment of the present invention;

FIG. 4 is a schematic structural diagram of a unit in a fuel cell controller according to an embodiment of the present invention; and

FIG. 5 is a flowchart of another fuel cell control method according to an embodiment of the present invention.

### DETAILED DESCRIPTION OF THE EMBODIMENTS

The technical solutions of the present invention are clearly and completely described in the following with reference to the accompanying drawings. It is obvious that the embodiments described are only a part rather than all of the embodiments of the present invention. All other embodiments obtained by persons skilled in the art based on the embodiments of the present invention without creative effects shall fall within the protection scope of the present invention.

Presently, in researches on fuel cells, conventional basic theories are adopted, especially in the researches on membrane electrode assembly (MEA, Membrane Electrode Assembly), which is the heart of fuel cell reaction, the three-phase interface in conventional electrochemistry is still adopted for analysis and explanation. A management system of fuel cells adopts a conventional chemical fluid dynamics, thermodynamics, and structural mechanics, and as a result, it is generally considered that a fuel cell system has the features of multiple parameters (temperature, humidity, voltage, current, resistance, flow rate, and flow), many changes, and multiple coupling, and cannot be accurately described and quantitatively controlled through mathematical formulas, so the current control and management methods mostly adopt simple feedback control methods. The reason is that the researches on fuel cells most focus on external apparent problems of heat, electricity, and water, while a proton exchange membrane, that is, a key factor in the reaction, is ignored.

In the method according to the embodiment of the present invention, a reaction point (referred to as a reaction singularity) in MEA, that is, a key factor in the fuel cell reaction, serves as an object for study. The reaction singularity has complete five reaction channels (channels for water, heat, gas, protons, and electrons), is a microcosm of a complete fuel cell, and fully indicates all characteristics of the fuel cell system. A complete fuel cell system includes a large number of reaction points.

For further description, the reaction singularity refers to a valid point in an MEA for a sustained electrochemical reaction, and must include substances such as catalyst Pt particles, carbon power particles, a proton exchange membrane, and a resin, and channels for five reaction elements of water, heat, electrons, protons, and gas. In the presence of the substances and the reaction elements, a sustained electrochemical reaction can be performed, otherwise, the electrochemical reaction cannot be sustained, and the point is not a valid reaction point.

An embodiment of the preset invention sets forth concepts of proton field and proton flow. In conventional researches, it is considered that protons are alternately transferred from a hydrogen side to an air side for reaction, and moreover, the transmission process needs to be performed in the form of hydrated proton. This is an important reason for the understanding that humidification is required for sustaining the reaction in the conventional theory. However, in the method according to the embodiment of the present invention, it is considered that, a proton field is similar to an electric field, a proton flow is similar to a current, and proton transmission is similar to electron transmission, provided that a potential difference exists, and the difference merely lies in symbols and conductor media. After the proton exchange membrane is saturated with water, the sulfonate group becomes active, which is a key factor for establishment of the proton field. The reaction principle is that hydrogen reacts with oxygen to generate water (2H₂+O₂=2H₂O), where hydrogen is provided by a hydrogen side, and oxygen is provided by an air side (oxygen is contained in the air). In the reaction process, once a proton A is generated on the hydrogen side, a proton B in a resin on the air side immediately participates in the reaction simultaneously, and the case does not exist that the proton A needs to penetrate the proton exchange membrane to participate the reaction. In the embodiment of the present invention, the complex fuel cell reactions are systematically organized and integrated by using five channels (water, heat, electrons, protons, and gas) dynamically, so as to manage the operation of the system by using characteristics of the channels.

During the management of the five channels, as for the gas channel, the hydrogen side controls merely a solenoid valve (including a gas inlet and a gas outlet), the air side (including oxygen for reaction and air for heat dissipation) is open to the atmosphere, where merely a fan is required to control the air volume, and no other management is required. Therefore, the management of gas channel is simple. As for the electron channel, the properties of the electron channel are fixed in the process of fabricating a membrane electrode, and no management is required. As for the proton channel, the properties are related to the form of the proton exchange membrane and the water and heat management. As for the water channel, the management is related to the heat channel management (water generated and water discharged are related to the temperature).

It can be seen that, except of the heat channel, among the four channels, management of some channels is simple or no management is required, while management of the other channels is related to the management of the heat channel. Therefore, as for the control over an air-cooling self-humidified fuel cell system, the core is heat management. When the output power of the fuel cell changes, the changes of the system that are caused by the change are directly reflected on the stack temperature. Therefore, taking the relationship between the output power and the stack temperature into consideration, a duty cycle of a heat sink axial-flow fan is controlled according to the relationship. Herein, the duty cycle refers to a ratio of an open time of the fan to a whole open and close cycle, for example, if the fan is opened for 2 seconds, closed for 1 second, opened for 2 seconds, and then closed for 1 second, and the process is repeated, the open and close cycle of the fan is 2 seconds, and the duty cycle is a ratio of the open time (2 seconds) to the whole open and close cycle (3 seconds), that is, 2/3. Through control over the duty cycle of the heat sink axial-flow fan is controlled, the stack is enabled to be in an optimal working temperature according to the output power and different duty cycle of the fan.

In the following, theoretical knowledge related to the control over an air-cooling self-humidified fuel cell is introduced.

A system power of the air-cooling self-humidified fuel cell may be expressed as:

Pₑ=V_{c}×I(W) (1)

where, Pₑ is the output power of the fuel cell, that is, the power of a loaded load, in watt (W); and V_{c} is a working voltage, in volt; and I is an output current, in ampere.

Because chemical energy is not completely converted into electric energy and a part of the chemical energy is converted into electric energy during the process of the fuel cell, in a general case, the heat emitting power of the air-cooling self-humidified fuel cell may be expressed as:

$${Q}_{generated} = {p}_{e} ( \frac{1.25}{{V}_{c}} - 1 ) ( W ) . \qquad ( 2 )$$

In addition, during the chemical reaction for generating electric energy of the fuel cell, water is generated, and the generation rate of water may generally be expressed as:

$${m}_{water} = 9.34 \times {10}^{- 8} \times \frac{{P}_{e}}{{V}_{c}} ( Kg \text{/} s ) . \qquad ( 3 )$$

In the working process of the fuel cell, corresponding heat dissipation needs to be performed, a basic formula of heat dissipation power Q_{sensible heat}:

Q_{sensible heat}=Cₚ×Δm×Δt (4),

where, Cₚ is a specific heat capacity of a heat sink substance (herein, specific heat capacity of the air, being a constant), Δm is a mass generation rate per unit time of the substance, in kg/s, and Δt is a temperature difference in heat dissipation.

According to the Dalton's law of partial pressure:

$${P}_{total} = {P}_{1} + {P}_{2} + … + {p}_{n} , \\ where , \\ {P}_{i} = {P}_{total} \times \frac{{n}_{i}}{{n}_{total}} , \qquad ( 5 )$$

And the Antoine equation:

$$Lg ( \frac{760 \times {p}_{{H}_{2} O}}{101.325} ) = 8.14 - \frac{1811}{244.5 + t} , \qquad ( 6 )$$

a formula of saturated vapor pressure of water is obtained:

$${p}_{{H}_{2} O} = \frac{101.325}{760} \times {10}^{( 8.14 - \frac{1811}{244.5 + {t}_{i}} )} , \qquad ( 7 )$$

in the formula, p_{H}_{₂}_{O} indicates a saturated vapor pressure of water, in kpa, and t is the temperature.

In a general case, a power of latent heat of vaporization of water may be expressed as:

$${Q}_{latent heat} = mq = 0.211 \times \frac{{P}_{e}}{{V}_{c}} \qquad ( 8 )$$

It can be known from Formula 3 that, when the output power of the fuel cell is low, because the amount of water generated is small, and accordingly, the heat emitting power (that is, Q_{sensible heat}) is low (referring to Formula 4), at this time, if the working temperature is high, dehydration easily occurs (that is, the amount of water generated is less than the amount of water discharged), so at this time, the working temperature cannot be too high. When the output power of the fuel cell is high, heating volume is high, and the amount of water generated is large, at this time, if the working temperature is low, water accumulation easily occurs (that is, the amount of water generated is larger than the amount of water discharged), so at this time, maintaining a high working temperature is beneficial for water discharge. It can be known from the analysis, the optimal working temperature of the stack is not a constant, but changes with the power. In the embodiment of the present invention, the key factor for realizing water-heat balance is that the amount of water generated is equal to the amount of water discharged and the amount of heat generated is equal to the amount of heat emitted when the fuel cell works, and the specific calculation method is shown below.

The relationship for achieving heat balance of the system may be expressed as:

Q_{generated}+Q_{sensible heat}+Q_{latent heat} (9),

where, Q_{generated} indicates the heat emitting power of the fuel cell, Q_{sensible heat} indicates the heat dissipation power, and Q_{latent heat} indicates an evaporation power of water. The formula indicates that the amount of heat generated is equal to the amount of heat emitted in the cell working process. Referring to Formula 2, the heat emitting power of the system may be expressed as:

$${Q}_{generated} = {p}_{e} ( \frac{1.25}{{V}_{c}} - 1 ) ( W )$$

It should be noted that, the water of the air-cooling self-humidified system is unlikely to be discharged in liquid state, in this embodiment, merely the situation that the water is discharged in the gas state is considered, where the voltage is calculated based on low heat value, and it is meant that cooling effect caused by water evaporation acts. In this case, heat leaving the fuel cell is in three types, that is, electric energy, steam latent heat, and heat taken by the cooling air.

It can be known from Formula 4, the heat taken by the cooling air may be expressed as:

Q_{sensible heat}=ρₐᵢᵣVₐᵢᵣCₐᵢᵣ(tᵢ−t₀) (10).

In the formula, Q_{sensible heat} is the heat power taken by the air; Vₐᵢᵣ is a flow of the cooling air, in kg/second; ρₐᵢᵣ is the air density; Cₐᵢᵣ is a specific heat capacity of the air; tᵢ is an outlet temperature of the air; and t₀ is an inlet temperature of the stack.

Referring to Formula 8, the heat power taken by the generated steam is expressed as:

$${Q}_{latent heat} = mq = 0.211 \times \frac{{P}_{e}}{{V}_{c}}$$

To reach heat balance, Formula 9 needs to be satisfied, Formulas 2, 8, 10 are introduced into Formula 9, to obtain the follow formula:

$${P}_{e} ( \frac{1.04}{{V}_{c}} - 1 ) = {ρ}_{air} {V}_{air} {C}_{air} ( {t}_{i} - {t}_{0} ) \qquad ( 11 )$$

In the embodiment of the present invention, the amount of water contained in the gas emitted on the air side is theoretically equal to the water generated in the reaction (ignoring the minor steam originally contained in the air), but considering that the proton exchange membrane is penetrable for water and the hydrogen side also need to exhaust gas (to reduce the hydrogen concentration and discharge impurities), a certain amount of water is discharged in the gas exhaust process, so that the amount of water discharged on the air side should be multiplied by a factor. According to experience, the factor may generally be 0.96, and the amount of water discharged on the air side is obtained by further calculation:

0.96Q_{generated water}=ρ_{H}_{₂}_{O}×V_{H}_{₂}_{O} (12).

According to Dalton's law of partial pressure, the following is obtained:

$$\frac{{V}_{{H}_{2} O}}{{V}_{air}} = \frac{{P}_{{H}_{2} O}}{{P}_{air}} , \qquad ( 13 )$$

where, V_{H}_{₂}_{O} is a volume of steam contained in the mixture gas discharged; Vₐᵢᵣ is a volume of air contained in the mixture gas discharged; P_{H}_{₂}_{O} is a pressure of steam in the mixture gas discharged; and Pₐᵢᵣ is a pressure of air in the mixture gas discharged.

Formula 7 is introduced into Formula 13, and a volume of water is obtained:

$${V}_{{H}_{2} O} = \frac{{V}_{air}}{{P}_{air}} \times \frac{101.325}{760} \times {10}^{( 8.14 - \frac{1811}{244.5 + {t}_{i}} )} . \qquad ( 14 )$$

According to Formulas 3, 12, 14, the following formula is obtained:

$$0.96 \times 9.34 \times {10}^{- 5} \times \frac{{P}_{e}}{{V}_{c}} = {ρ}_{{H}_{2} O} \times \frac{{V}_{air}}{{p}_{air}} \times \frac{101.325}{760} \times {10}^{( 8.14 - \frac{1811}{244.5 + {t}_{i}} )} \qquad ( 15 )$$

Because the sum of the pressure of steam and the air is equal to the atmospheric pressure P₀, according to Formula 7, the following formula is obtained:

$${P}_{air} = {P}_{0} - \frac{101.325}{760} \times {10}^{( 8.14 - \frac{1811}{244.5 + t} )} . \qquad ( 16 )$$

Formula 16 is introduced into Formula 15, the following formula is obtained:

$$0.96 \times 9.34 \times {10}^{- 5} \times \frac{{P}_{e}}{{V}_{c}} = \frac{{ρ}_{{H}_{2} O} \times {V}_{air}}{\frac{{P}_{0}}{\frac{101.325}{760} \times 10 ( 8.14 - \frac{1811}{2445 + {t}_{i}} )} - 1} \qquad ( 17 )$$

The left side of Formula (17) indicates the quality of water generated in unit time, and the left side indicates the quality of water contained in the mixture air discharged in unit time, and this formula is combined with Formula 11 (through division), a relationship merely containing V_{c}, tᵢ and t₀ is deduced, where t₀ indicates an ambient temperature and can be directly measured, V_{c} indicates a working voltage of the fuel cell and can also be directly measured. In this way, a corresponding stack temperature tᵢ can be obtained, and the obtained tᵢ is introduced into the formula Q_{sensible heat}=ρₐᵢᵣVₐᵢᵣCₐᵢᵣ(tᵢ−t₀), so as to obtain the amount of required air. The amount of air is corresponding to the duty cycle of the fan, and the correspondence between the amount of air and the duty cycle of the fan can be obtained through experiments, and generally, the amount of air is in direct proportion to the duty cycle of the fan in a certain range. It can be known from the foregoing introduction, in order to enable the fuel cell to work in a preferred working temperature, that is, to enable the fuel cell to reach a heat balance state as far as possible in the working process, water balance needs to be achieved in the working process of the fuel cell.

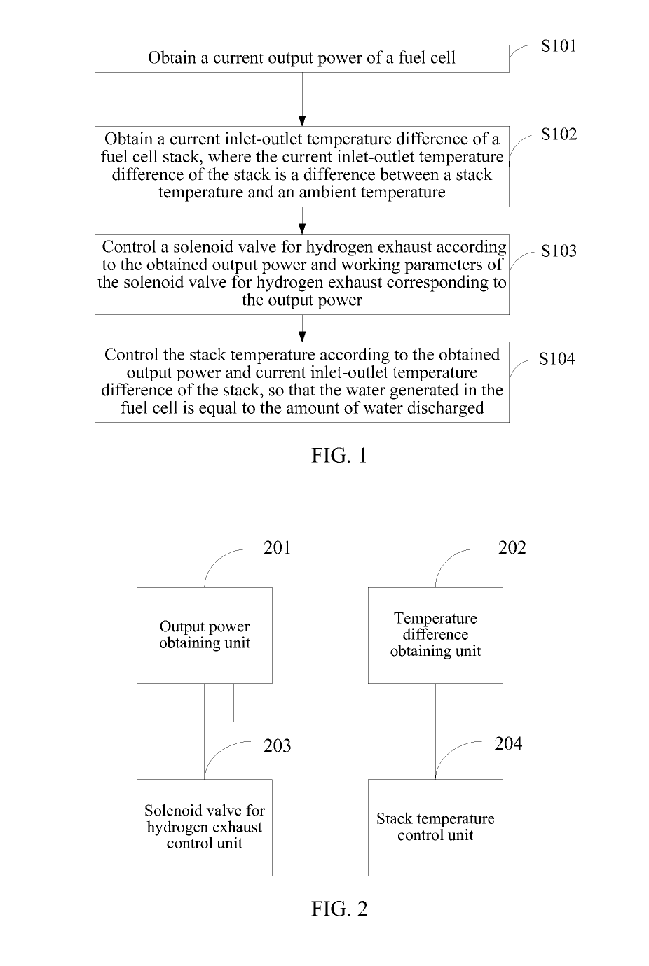

According to the basic theory, an embodiment of the present invention provides a fuel cell control method. FIG. 1 shows a specific process of the method, where the method includes the following steps:

S101: Obtain a current output power of a fuel cell.

When a fuel cell is started, if the fuel cell needs to start to work, a solenoid valve of a hydrogen inlet in the fuel cell needs to be opened, and a corresponding load needs to be loaded at two ends of the fuel cell. When all the conditions are satisfied, the fuel cell starts to work, and converts stored chemical energy into electric energy and outputs the electric energy according to the rated power of the loaded load. In S101, the output power of the fuel cell can be obtained through direct measurement.

S102: Obtain a current inlet-outlet temperature difference of a fuel cell stack, where the current inlet-outlet temperature difference of the stack is a difference between a stack temperature and an ambient temperature.

In S102, the current stack temperature (by directly reading a value of a temperature sensor located in the stack) and the current ambient temperature of the fuel cell may be directly obtained, and the current inlet-outlet temperature difference of the fuel cell stack is obtained by subtracting the current ambient temperature from the obtained current stack temperature of the fuel cell.

S103: Control a hydrogen exhaust solenoid valve according to the obtained output power and working parameters of the hydrogen exhaust solenoid valve corresponding to the output power.

In S103, the controlling of the hydrogen exhaust solenoid valve according to the obtained output power includes controlling the open time interval of the hydrogen exhaust solenoid valve and controlling the length of open time of the hydrogen exhaust solenoid valve. In a general case, correspondence exists between the output power of the fuel cell and the open time interval of the hydrogen exhaust solenoid valve and the length of open time of the hydrogen exhaust solenoid valve in a certain range, and the correspondence may be expressed by an experimental formula.

Specifically, when the output power is high, the open time interval should be reduced, and at the same time, the length of open time should be increased, because when the output power is low, the temperature is raised, the amount of water generated is increased, the partial pressure of steam is increased, and the concentration of hydrogen is reduced, as a result, a high power cannot be output; therefore, the open time interval needs to be reduced and the open time needs to be increased to discharge the accumulated stream and liquid water in time, so as to maintain the concentration of hydrogen.

On the contrary, when the output power is low, the open time interval should be increased, and at the same time, the length of open time at each time should be reduced, because when the output power is low, the temperature is low, the amount of water generated is small, and the partial pressure of steam is low, so the influence on the hydrogen concentration is low; therefore, it is not required to open the solenoid valve for exhaust (the hydrogen exhaust solenoid valve) frequently due to the problem of hydrogen concentration. In this case, the open time interval may be increased and the length of open time may be reduced to save the hydrogen; and meanwhile, because the number of times of opening is reduced (the increasing the open time interval is equivalent to reducing the number of times of opening in a certain period of time), the service life of the solenoid valve for exhaust is prolonged.

Through the foregoing control, proper output power can be output, in other words, output power can be adjusted through this feedback control, one can control the hydrogen exhaust solenoid valve through output power and corresponding working parameters to keep balance among gas, water and heat within the battery, and thus to output proper (optimized) output power. Here, the value of the proper output power can be called normal output power, and when the output power is larger or smaller than the normal power, it should be controlled as described above.

It can be understood that, the open time interval and the length of open time at each time should change in a certain range, but cannot be increased or reduced unlimitedly. For example, if the open time interval is reduced unlimitedly, it is equivalent to that the valve is opened eventually, so that the pressure of hydrogen is equal to the atmospheric pressure, and a certain concentration cannot be reached and the high power cannot be output. Similarly, if the length of open time is increased unlimitedly, it is equivalent to that the valve is opened eventually, so that the hydrogen concentration cannot be ensured. Therefore, in the embodiment of the present invention, the open time interval and the length of open time at each time are controlled based on a certain range, and persons skilled in the art can determine the specific range according to actual applications. For example, the open time interval of the hydrogen exhaust solenoid valve can be adjusted by using the following formula:

Δt=75−60 (Pₒᵤₜₚᵤₜ/Pₘₐₓ), where, Δt indicates the open time interval, in second, Pₒᵤₜₚᵤₜ indicates the output power, and Pₘₐₓ indicates a maximum output power.

It can be known from the formula that, the open time interval is not increased or reduced unlimited, but changes in the range of [15, 75] (merely theoretical analysis, and in actual application, Pₒᵤₜₚᵤₜ is not 0, so the open time interval is greater than 15 in actual application).

Meanwhile, the following formula may be used to adjust the length of open time of the hydrogen exhaust solenoid valve:

Δt′=800 (Pₒᵤₜₚᵤₜ/Pₘₐₓ), where, Δt′ indicates the length of open time, in millisecond, Pₒᵤₜₚᵤₜ indicates the output power, and Pₘₐₓ indicates the maximum output power.

It should be noted that, the formulas are merely several specific experimental formulas provided in the present invention, and persons skilled in the art can adjust the open time interval and the length of time by using other different experimental formulas according to actual applications and specific application scenarios, which is not limited herein.

S104: Control the stack temperature according to the obtained output power and current inlet-outlet temperature difference of the stack, so that the amount of water generated in the fuel cell is equal to the amount of water discharged.

In S104, the controlling of the stack temperature according to the obtained output power and current inlet-outlet temperature difference of the stack is implemented by controlling the duty cycle of an axial-flow fan. In the embodiment of the present invention, the amount of air required for the stack is calculated according to the output power and the current inlet-outlet temperature difference of the stack, and then the duty cycle of the axial-flow fan is controlled according to the calculated amount of air. Meanwhile, in the embodiment of the present invention, the amount of air is coupled to the temperature of the stack (that is, the amount of air and the temperature may be derived from each other, referring to Formula 17). Therefore, by calculating the amount of air and controlling the duty cycle of the fan, the control over the stack temperature is implemented.

In specific control, when the amount of required air is large, (the temperature needs to be decreased), the duty cycle of the axial-flow fan may be increased; on the contrary, when the amount of required air is small (the temperature needs to be decreased), the duty cycle of the axial-flow fan may be reduced. In addition, persons skilled in the art can adopt other manners (for example, increasing the number of the fan and increasing the rotation rate of the fan) to control the amount of air, which is not limited herein.

The further description has been introduced in the foregoing theory introduction part, and the amount of air required for the stack can be calculated with an output voltage of the fuel cell and the current inlet-outlet temperature difference of the stack. Herein, output voltage of the fuel cell may be directly obtained with the obtained input power and the output current. After the amount of air required for the stack is calculated, correspondence exists between the amount of air and the duty cycle of the axial-flow fan, that is, according to the correspondence that exists between the obtained amount of air and the duty cycle of the axial-flow fan, the duty cycle of the axial-flow fan can be obtained. By adjusting the duty cycle of the axial-flow fan, the amount of air of the stack in the fuel cell is adjusted, and the water that is in the fuel cell is further adjusted. When the amount of water generated in the fuel cell is equal to the amount of water discharged, heat balance of the fuel cell is achieved, so that the fuel cell can work at a preferred working temperature. Therefore, when the stack temperature is controlled by using the obtained output power and inlet-outlet temperature difference of the stack, when the amount of water generated in the fuel cell is equal to the amount of water discharged, it indicates that the temperature of the stack is properly adjusted. It should be noted that, when the duty cycle of the axial-flow fan is controlled by using the obtained amount of air, the control may be performed by selecting a method corresponding to PID (Proportion Integration Differentiation, proportion integration differentiation) regulation according to the correspondence between the amount of air and the duty cycle of the axial-flow fan, where the PID regulation is completed by a corresponding controller, which is a well known technology to persons skilled in the art, and details are not described herein again.

In a fuel cell control method provided in the embodiment of the present invention, the current output power of the fuel cell and the current inlet-outlet temperature difference of the stack are obtained, and working parameters of the hydrogen exhaust solenoid valve and the stack working temperature are controlled in the reaction process of the fuel cell according to the obtained values, so that the amount of water generated in the working process of the fuel cell is equal to the amount of water discharged, and water balance is achieved in the fuel cell, thereby achieving heat balance in the fuel cell, ensuing that the fuel cell works at a preferred temperature, ensuring steady output of the cell, and prolonging the working life.

Accordingly, an embodiment of the present invention further provides a fuel cell controller. FIG. 2 shows a structure of the device, and the controller includes:

an output power obtaining unit 201, configured to obtain a current output power of a fuel cell;

a temperature difference obtaining unit 202, configured to obtain a current inlet-outlet temperature difference of a fuel cell stack, where the current inlet-outlet temperature difference of the stack is a difference between a stack temperature and an ambient temperature;

a hydrogen exhaust solenoid valve control unit 203, configured to control a hydrogen exhaust solenoid valve according to the output power of the fuel cell obtained by the output power obtaining unit and working parameters of the hydrogen exhaust solenoid valve corresponding to the output power; and

a stack temperature control unit 204, configured to control the stack temperature according to the output power of the fuel cell obtained by the output power obtaining unit and the fuel cell stack inlet-outlet temperature difference obtained by the temperature difference obtaining unit, so that the amount of water generated in the fuel cell is equal to the amount of water discharged.

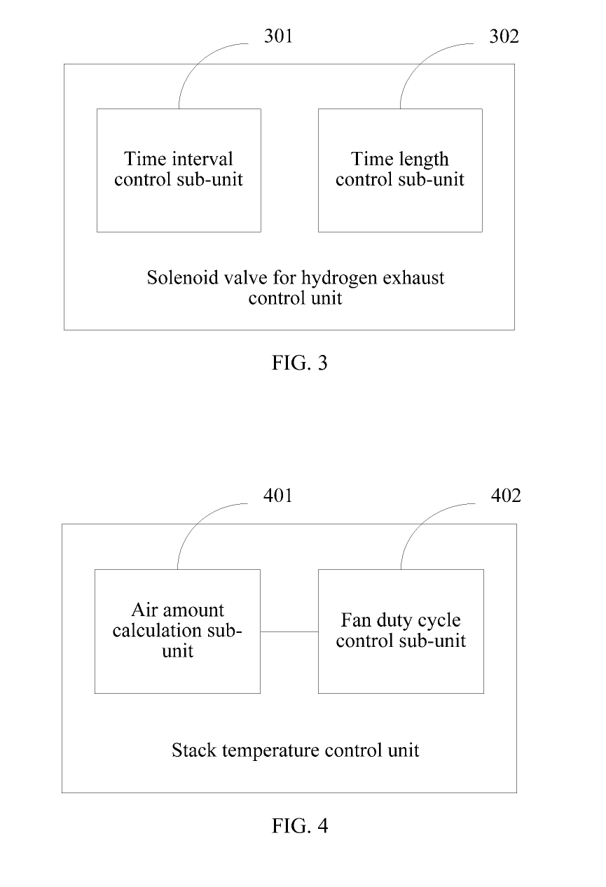

The device is further divided, and the hydrogen exhaust solenoid valve control unit 203 may include a structure shown in FIG. 3:

a time interval control sub-unit 301, configured to control an open time interval of the hydrogen exhaust solenoid valve according to the output power; and

a time length control sub-unit 302, configured to control a length of open time of the hydrogen exhaust solenoid valve according to the output power.

The control may be performed by adopt the following method:

when the output power is high, the time interval control sub-unit 301 reduces the open time interval, and at the same time, the time length control sub-unit 302 increases the length of open time; and

when the output power is low, the time interval control sub-unit 301 increases the open time interval, and at the same time, the time length control sub-unit 302 reduces the length of open time.

Because the control over the stack temperature is actually implemented through the control over a duty cycle of the axial-flow fan, the stack temperature control unit 304 may include a structure shown in FIG. 4:

an air amount calculation sub-unit 401, configured to calculate the amount of air required for the stack according to the output power of the fuel cell obtained by the output power obtaining unit and the fuel cell stack inlet-outlet temperature difference obtained by the temperature difference obtaining unit; and

a fan duty cycle control sub-unit 402, configured to control the duty cycle of the axial-flow fan according to the amount of air required for the stack calculated by the air amount calculation sub-unit.

Specifically, in the embodiment of the present invention, the air amount calculation sub-unit 401 calculates the amount of air required for the stack according to the output power and the current inlet-outlet temperature difference of the stack, and the fan duty cycle control sub-unit 402 controls the duty cycle of the axial-flow fan according to the calculated amount of air. Meanwhile, in the embodiment of the present invention, the amount of air is coupled to the temperature of the stack (that is, the amount of air and the temperature may be derived from each other, referring to Formula 17). Therefore, through calculating the amount of air and controlling the duty cycle of the fan, the control over the stack temperature is implemented.

When the fan duty cycle control sub-unit 402 performs specific control, when the amount of required air is large (when the temperature needs to be decreased), the duty cycle of the axial-flow fan is increased; and on the contrary, when the amount of required air is small (when the temperature needs to be decreased), the duty cycle of the axial-flow fan is reduced. In addition, persons skilled in the art may also adopt other methods (for example, increasing the number of the fan and increasing the rotation rate of the fan) to control the amount of air, which is not limited herein.

In a fuel cell controller provided by an embodiment of the present invention, by obtaining the current output power of the fuel cell and the current inlet-outlet temperature difference of the stack, and controlling the hydrogen exhaust solenoid valve working parameter and the stack working temperature in the process of fuel cell reaction according to the obtained values, so that the amount of water generated in the working process of the fuel cell is equal to the amount of water discharged, and water balance is achieved in the fuel cell, thereby achieving heat balance in the fuel cell, and finally realizing the purpose that the fuel cell works at a preferred temperature.

In combination with the method, the device, and the specific application scenario, the technical solutions provided by the present invention are further introduced:

In communication networks, a fuel cell is a good solution for the problem of power supply of base stations in remote areas due to the characteristics of high efficiency, energy saving, high reliability, and high environmental adaptability.

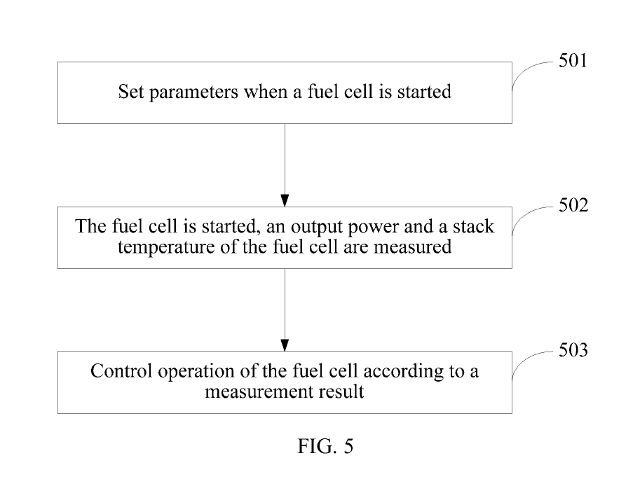

In a general case, the power supply system of a base station adopts the light-mixture power supply manner, where solar energy serves as the main energy of the whole power supply system. When it is sunny, the solar energy supplies power for primary devices and charges a secondary battery; when it rains continuously, after the discharge capacity of the secondary battery exceeds a set value, the fuel cell needs to be started to supply power for the primary device and charges the secondary battery. The control policy of the fuel cell in the base station includes steps in FIG. 5:

Step 501: Set parameters when a fuel cell is started.

In step 501, when the fuel cell is started, the output voltage of the fuel cell needs to be set according to requirements, for example, if the fuel cell is to charge the secondary battery, the output power of the fuel cell needs to be set in the range of the voltage of the secondary battery.

Meanwhile, a stack temperature also needs to be set, and the stack temperature may be obtained by calculation with the output voltage of the fuel cell and an ambient temperature.

Additionally, the duty cycle of an axial-flow fan needs to be preset, where the duty cycle of the fan may be set in the following manner. The stack temperature is calculated according to a measured ambient temperature and the set output voltage, the amount of air required for the stack is calculated according to the stack temperature, and the duty cycle of the axial-flow fan is set according to the obtained amount of air.

Step 502: The fuel cell is started, and the output power and the stack temperature of the fuel cell are measured.

In step 502, in a general case, because the change of the ambient temperature is not large, it may be considered that the ambient temperature is constant in a certain period of time. Moreover, because the output power of the fuel cell and the stack temperature continuously change, for a good control effect, the output power of the fuel cell and the stack temperature need to be measured in real time.

Step 503: Control operation of the fuel cell according to a measurement result

In step 503, the open time interval and the length of open time of the hydrogen exhaust solenoid valve are controlled according to the output power of the fuel cell measured in step 502 and a value of the hydrogen exhaust solenoid valve corresponding to the power.

Accordingly, the duty cycle of the axial-flow fan is controlled according to the measured output power and stack temperature, and the stack temperature is controlled through an axial-flow fan.

The purpose of the control is to achieve water balance in the fuel cell, so that the fuel cell can work in a preferred state, thereby ensuring steady output of the cell, and prolonging the service life.

In addition to communication devices such as a base station, the fuel cell may be widely used in applications for emergency power backup such as for homes, hotels, resorts, and offices, provided that the output current is subjected to direct current/alternate current conversion, the fuel cell can meet the requirements of most of powered equipment in the applications.

Persons skilled in the art should understand that all or a part of the steps of the method according to the embodiments of the present invention may be implemented by a program instructing relevant hardware. The program may be stored in a computer readable storage medium. When the program is run, the steps of the method according to the embodiments of the present invention are performed. The storage medium may be any medium that is capable of storing program codes, such as a read-only memory (ROM), a random access memory (RAM), a magnetic disk, and an optical disk

The above description of the embodiments that are disclosed enables persons skilled in the art to implement or use the present invention. Various modifications of the embodiments are obvious to persons skilled in the art, and general principles defined in the specification may be implemented in other embodiments without departing from the spirit or scope of the present invention. Therefore, the present invention is not limited to the embodiments described in the specification, but conforms to the widest scope consistent with the principle and novel features disclosed in the specification.

What is claimed is:

1. A fuel cell control method, comprising:
obtaining a current output power of a fuel cell;
obtaining a current inlet-outlet temperature difference of a fuel cell stack, wherein the current inlet-outlet temperature difference of the stack is a difference between a stack temperature and an ambient temperature;
controlling a hydrogen exhaust solenoid valve according to working parameters of the hydrogen exhaust solenoid valve corresponding to the output power; and
controlling the stack temperature according to the output power and the current inlet-outlet temperature difference of the stack, so that the amount of water generated in the fuel cell is equal to the amount of water discharged.

2. The method according to claim 1, wherein the working parameters are a value of open time interval of the hydrogen exhaust solenoid valve and a value of length of open time of the hydrogen exhaust solenoid valve; the controlling the hydrogen exhaust solenoid valve according to working parameters of the hydrogen exhaust solenoid valve corresponding to the output power comprises:
controlling an open time interval of the hydrogen exhaust solenoid valve according to the value of open time interval of the hydrogen exhaust solenoid valve corresponding to the output power; and, controlling a length of open time of the hydrogen exhaust solenoid valve according to the value of length of open time of the hydrogen exhaust solenoid valve corresponding to the output power.

3. The method according to claim 2, wherein the controlling an open time interval of the hydrogen exhaust solenoid valve according to the value of open time interval of the hydrogen exhaust solenoid valve corresponding to the output power; and, controlling a length of open time of the hydrogen exhaust solenoid valve according to the value of length of open time of the hydrogen exhaust solenoid valve corresponding to the output power comprises:
when the output power is higher than normal value, reducing the open time interval according to the value of time interval of the hydrogen exhaust solenoid valve, which is corresponding to the higher output power, and at the same time, increasing the length of open time according to the value of length of open time of the hydrogen exhaust solenoid valve, which is corresponding to the higher output power;
when the output power is lower than normal value, increasing the open time interval according to the value of time interval of the hydrogen exhaust solenoid valve, which is corresponding to the lower output power, and at the same time, reducing the length of open time according to the value of length of open time of the hydrogen exhaust solenoid valve, which is corresponding to the lower output power.

4. The method according to claim 1, wherein the controlling the stack temperature according to the output power and the current inlet-outlet temperature difference of the stack comprises:
controlling a duty cycle of an axial-flow fan according to the output power and the current inlet-outlet temperature difference of the stack, and controlling the stack temperature through the axial-flow fan.

5. The method according to claim 4, wherein the controlling the duty cycle of the axial-flow fan according to the output power and the current inlet-outlet temperature difference of the stack comprises:
calculating the amount of air required for the stack according to the output power and the current inlet-outlet temperature difference of the stack, and controlling the duty cycle of the axial-flow fan according to correspondence between the amount of air and the duty cycle of the axial-flow fan, comprising:
when the amount of required air is larger than normal value, increasing the duty cycle of the axial-flow fan; and
when the amount of the air is smaller than normal value, reducing the duty cycle of the axial-flow fan.

6. The method according to claim 5, wherein the controlling the duty cycle of the axial-flow fan according to the correspondence between the amount of air and the duty cycle of the axial-flow fan comprises:
controlling the duty cycle of the axial-flow fan by adopting proportion integration differentiation according to the correspondence between the amount of the air and the duty cycle of the axial-flow fan.

7. A fuel cell controller, comprising:
an output power obtaining unit, configured to obtain a current output power of a fuel cell;
a temperature difference obtaining unit, configured to obtain a current inlet-outlet temperature difference of a fuel cell stack, wherein the current inlet-outlet temperature difference of the stack is a difference between a stack temperature and an ambient temperature;
a hydrogen exhaust solenoid valve control unit, configured to control a hydrogen exhaust solenoid valve according to working parameters of the hydrogen exhaust solenoid valve corresponding to the output power of the fuel cell obtained by the output power obtaining unit;
a stack temperature control unit, configured to control the stack temperature according to the output power of the fuel cell obtained by the output power obtaining unit and the fuel cell stack inlet-outlet temperature difference obtained by the temperature difference obtaining unit, so that the amount of water generated in the fuel cell is equal to the amount of water discharged.

8. The fuel cell controller according to claim 7, wherein the working parameters are a value of open time interval of the hydrogen exhaust solenoid valve and a value of length of open time of the hydrogen exhaust solenoid valve, the hydrogen exhaust solenoid valve control unit comprises:
a time interval control sub-unit, configured to control an open time interval of the hydrogen exhaust solenoid valve according to the value of open time interval of the hydrogen exhaust solenoid valve corresponding to the output power;
a time length control sub-unit, configured to control a length of open time of the hydrogen exhaust solenoid valve according to the value of length of open time of the hydrogen exhaust solenoid valve corresponding to the output power;
wherein:
when the output power is higher than normal value, the time interval control sub-unit reduces the open time interval according to the value of time interval of the hydrogen exhaust solenoid valve, which is corresponding to the higher output power, and at the same time, the time length control sub-unit increases the length of open time according to the value of length of open time of the hydrogen exhaust solenoid valve, which is corresponding to the higher output power; and
when the output power is lower than normal value, the time interval control sub-unit increases the open time interval according to the value time interval of the hydrogen exhaust solenoid valve, which is corresponding to the lower output power, and at the same time, the time length control sub-unit reduces the length of open time according to the value of length of open time of the hydrogen exhaust solenoid valve, which is corresponding to the lower output power.

9. The fuel cell controller according to claim 7, wherein the stack temperature control unit comprises:
an air amount calculation sub-unit, configured to calculate the amount of air required for the stack according to the output power of the fuel cell obtained by the output power obtaining unit and the fuel cell stack inlet-outlet temperature difference obtained by the temperature difference obtaining unit; and
a fan duty cycle control sub-unit, configured to control a duty cycle of an axial-flow fan according to the amount of air required for the stack calculated by the air amount calculation sub-unit, when the amount of required air is larger than normal value, increase the duty cycle of the axial-flow fan; and when the amount of air is smaller than normal value, reduce the duty cycle of the axial-flow fan.
